(19) United States
(12) Patent Application Publication
(10) Pub. No.: US 2007/0098240 A1
(43) Pub. Date: May 3, 2007

(54) IMAGE DIAGNOSTIC APPARATUS

(76) Inventor: Osamu Takayama, Tokyo (JP)

Correspondence Address: Patrick W. Rasche;Armstrong Teasdale LLP, One Metropolitan Square, Suite 2600, St. Louis, MO, 63102, US

(21) Appl. No.: 11/550,053

(22) Filed: Oct. 17, 2006

(30) Foreign Application Priority Data
Oct. 18, 2005 (JP) 2005-303138

(51) Int. Cl. G06K 9/00

(52) U.S. Cl. 382/128; 600/410

(57) ABSTRACT

For the purpose of improving operability, and hence, imaging efficiency, a storage section (34) stores a sequence of inputting operational data into a plurality of input fields displayed by a display section (33), and the display section (33) sequentially highlights the input fields corresponding to the sequence of inputting stored by the storage section (34).

### CROSS REFERENCE TO RELATED APPLICATIONS

This application claims the benefit of Japanese Application No. 2005-303138 filed Oct. 18, 2005.

### BACKGROUND OF THE INVENTION

The present invention relates to an image diagnostic apparatus, and particularly, to an image diagnostic apparatus that displays a plurality of input fields for a human operator to input operational data.

Image diagnostic apparatuses, such as a magnetic resonance imaging (MRI) apparatus, are known for capturing a slice image of a cross-sectional plane of a subject, and are widely used in various fields including a medical application and an industrial application.

For example, when capturing a slice image using a magnetic resonance imaging apparatus, a subject to be examined is placed in a space in which a static magnetic field is generated to align the direction of spins of protons in the subject, which is a living body, with the direction of the static magnetic field, resulting in the spins incorporating magnetization vectors. Then, an RF coil emits electromagnetic waves at a resonance frequency onto the subject to cause a nuclear magnetic resonance phenomenon to change the magnetization vectors of the protons in the subject. The magnetic resonance imaging apparatus receives magnetic resonance signals from the protons in the subject recovering their original magnetization vectors at the RF coil, and produces a slice image based on the received magnetic resonance signals.

Such an image diagnostic apparatus is operated by an operating apparatus. For example, the operating apparatus is constituted by a graphical interface whose display screen shows a plurality of input fields for an operator to input operational data. The operator uses a keyboard, a pointing device, and the like, to input operational data corresponding to the plurality of input fields displayed on the display screen. The operating apparatus thereafter operates based on the input operational data (see Patent Document 1, for example).

[Patent Document 1] Japanese Patent Application Laid Open No. 2002-165775

In such an operating apparatus, however, it may sometimes take a long time in the input operation because a plurality of input fields are displayed on a display screen and the operator sequentially inputs operational data into the plurality of input fields. For example, an operator inexperienced in the input operation sometimes requires a long time in this input operation, leading to lowering of imaging efficiency in imaging a subject. Especially in a magnetic resonance imaging apparatus, the input operation is relatively complicated and the aforementioned inconvenience may be dominantly encountered.

### SUMMARY OF THE INVENTION

It is therefore an object of the present invention to provide an image diagnostic apparatus capable of improving operability, and hence, imaging efficiency.

To attain the aforementioned object, the present invention provides an image diagnostic apparatus comprising an imaging apparatus for imaging a subject and an operating apparatus for operating said imaging apparatus, wherein said operating apparatus comprises: a display section for displaying a plurality of input fields for an operator to input operational data; and a storage section for storing a sequence of inputting said operational data into said plurality of input fields displayed by said display section, said display section sequentially highlighting said input fields corresponding to said sequence of inputting stored by said storage section.

According to the present invention, there is provided an image diagnostic apparatus capable of improving operability, and hence, imaging efficiency.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the configuration of a magnetic resonance imaging apparatus 1 in an embodiment in accordance with the present invention.

FIG. 2 is a flow chart showing an operation in imaging a subject in the present embodiment.

FIG. 3 shows images representing input fields displayed by the display section 33 on its display screen in the present embodiment.

FIG. 4 shows images in which a scan parameter is highlighted by the display section 33 in the present embodiment.

FIG. 5 shows images in which text information corresponding to input operational data is displayed by the display section 33 in the present embodiment.

FIG. 6 shows images in which a command to start a scan is highlighted by the display section 33 in the present embodiment.

### DETAILED DESCRIPTION OF THE INVENTION

An exemplary embodiment of the present invention will now be described with reference to the accompanying drawings.

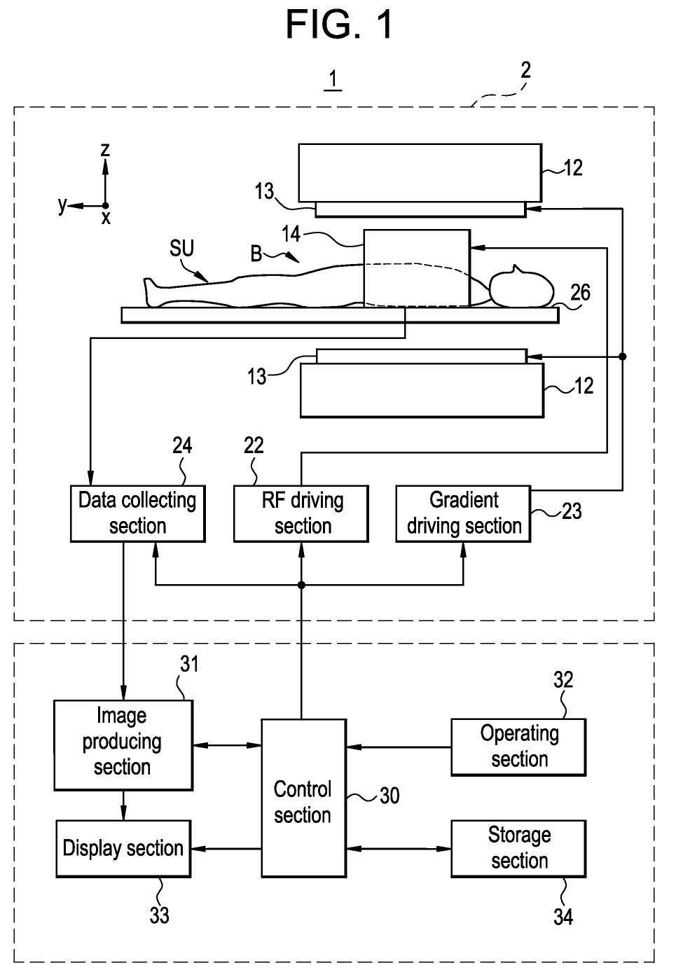

FIG. 1 is a block diagram showing the configuration of a magnetic resonance imaging apparatus 1 in an embodiment in accordance with the present invention.

As shown in FIG. 1, the magnetic resonance imaging apparatus 1 has a scanning section 2 and an operation console section 3.

Now the scanning section 2 will be described.

The scanning section 2 has a static magnetic field magnet section 12, a gradient coil section 13, an RF coil section 14, an RF driving section 22, a gradient driving section 23, a data collecting section 24, and a cradle 26, as shown in FIG. 1, for conducting a scan to acquire magnetic resonance signals as raw data from a subject SU laid in an imaging space B in which a static magnetic field is generated.

The components in the scanning section 2 will now be described one by one.

The static magnetic field magnet section 12 is comprised of, for example, a pair of permanent magnets to generate a static magnetic field in the imaging space B in which the subject SU is received. The static magnetic field magnet section 12 here generates the static magnetic field such that the direction of the static magnetic field aligns with a direction Z that is perpendicular to the body axis direction of the subject SU. Alternatively, the static magnetic field magnet section 12 may be comprised of a superconductive magnet.

The gradient coil section 13 generates a gradient magnetic field in the imaging space B in which the static magnetic field is generated, to add positional information to magnetic resonance signals received by the RF coil section 14. The gradient coil section 13 here is comprised of three coil systems to generate gradient magnetic fields in a frequency encoding direction, a phase encoding direction, and a slice selective direction, depending upon imaging conditions. In particular, the gradient coil section 13 applies a gradient magnetic field in the slice selective direction of the subject SU to select a slice through the subject SU to be excited by the RF coil section 14 transmitting an RF pulse. The gradient coil 13 also applies a gradient magnetic field in the phase encoding direction of the subject SU to phase-encode magnetic resonance signals from the slice excited by the RF pulse. The gradient coil section 13 moreover applies a gradient magnetic field in the frequency encoding direction of the subject SU to frequency-encode magnetic resonance signals from the slice excited by the RF pulse.

The RF coil section 14 is disposed to surround the imaged region in the subject SU, as shown in FIG. 1. The RF coil section 14 transmits an RF pulse, which is an electromagnetic wave, to the subject SU laid in the imaging space B in which the static magnetic field is generated by the static magnetic field magnet section 12, to generate a high frequency magnetic field and excite spins of protons within the imaged region in the subject SU. The RF coil section 14 then receives electromagnetic waves generated by the excited protons in the subject SU as magnetic resonance signals.

The RF driving section 22 drives the RF coil section 14 to transmit an RF pulse for generating a high frequency magnetic field in the imaging space B. The RF driving section 22 modulates a signal from an RF oscillator into a signal of predetermined timing and envelope using a gate modulator based on a control signal from the control section 30, and then amplifies the signal modulated by the gate modulator at an RF power amplifier and outputs it to the RF coil section 14, thus transmitting the RF pulse.

The gradient driving section 23 applies a gradient pulse to the gradient coil section 13 and drives the section 13 based on a control signal from the control section 30, to generate a gradient magnetic field in the imaging space B in which the static magnetic field is generated. The gradient driving section 23 has three driving circuits (not shown) corresponding to the three systems of the gradient coil section 13.

The data collecting section 24 collects magnetic resonance signals received by the RF coil section 14 and outputs them to an image producing section 31 based on a control signal from the control section 30. The data collecting section 24 collects magnetic resonance signals subjected to phase encoding and frequency encoding, corresponding to a k-space. The data collecting section 24 here has a phase detector that phase-detects magnetic resonance signals received by the RF coil section 14 with reference to the output from the RF oscillator in the RF driving section 22. Thereafter, an A/D converter is used to convert the magnetic resonance signals, which are analog signals, into digital signals. The data collecting section 24 stores the magnetic resonance signals in the memory and then outputs them to the image producing section 31.

The cradle 15 has a table for laying thereon the subject SU. The cradle section 26 is moved between the inside and outside of the imaging space B based on a control signal from the control section 30.

Now the operation console section 3 will be described.

The operation console section 3 has a control section 30, an image producing section 31, an operating section 32, a display section 33, and a storage section 34, as shown in FIG. 1.

The components in the operation console section 3 will now be described one by one.

The control section 30 has a computer and a program for causing the relevant components to execute an operation corresponding to a predetermined scan using the computer, and is supplied with operational data from the operating section 32. The control section 30 outputs for control a control signal to the RF driving section 22, gradient driving section 23, and data collecting section 24 to conduct a predetermined scan based on the operational data input from the operating section 32. The control section 30 also outputs for control a control signal to the image producing section 31, display section 33, and storage section 34 based on the operational data input from the operating section 32.

The image producing section 31 has a computer and a program for executing predetermined data processing using the computer, acquires magnetic resonance signals collected by the data collecting section 24, and applies image processing to the acquired magnetic resonance signals to produce an image for a slice through the subject SU based on a control signal from the control section 30. The image producing section 31 then outputs the produced image to the display section 33.

The operating section 32 is comprised of operation devices such as a keyboard and a pointing device. The operating section 32 is supplied with operational data by the operator, and outputs the operational data to the control section 30.

The display section 33 is comprised of a display device such as a CRT, and displays an image on its display screen based on a control signal from the control section 30. In the present embodiment, the display section 33 displays on its display screen a plurality of images with respect to input fields for the operator to input operational data via the operating section 32. For example, the display section 33 displays dialog boxes for inputting scan parameters such as the number of echoes, echo time, repetition time, and band width, and subject information such as the name of the subject, and buttons for inputting a command to start a scan, and displays the input fields corresponding to them on its display screen as text information. As will be discussed later, a sequence of inputting operational data into the plurality of input fields displayed by the display section 33 is stored by the storage section 34, and the display section 33 sequentially highlights the input fields corresponding to the sequence of inputting stored in the storage section 34. In particular, after operational data corresponding to a first one of the plurality of input fields that is highlighted has been input by the operator via the operating section 32, the display section 33 highlights a second input field into which operational data is to be input next to the first input field according to the sequence of inputting stored by the storage section 34. For example, the display section 33 achieves the highlight display by blinking the input fields on the display screen. Specifically, for example, if the storage section 34 stores a sequence of inputting such that scan parameters including the number of echoes, echo time, repetition time, and band width are sequentially input and then a command to start a scan is input, the display section 33 performs highlight display by sequentially blinking the input fields for the number of echoes, echo time, repetition time, band width, and scan start according to the sequence of inputting. Besides, in response to data for a slice image of the subject SU from the image producing section 31 generated based on magnetic resonance signals from the subject SU, the display section 33 displays the slice image on the display screen.

The storage section 34 is comprised of a memory, and stores several kinds of data. The storage device 33 has the stored data accessed by the control section 30 as needed. In the present embodiment, the storage section 34 stores a sequence of inputting operational data into the plurality of input fields displayed by the display section 33. For example, the storage section 34 stores a sequence of inputting operational data into the input fields such that scan parameter including the number of echoes, echo time, repetition time, and band width are sequentially input and then a command to start a scan is input.

Now an operation in imaging the subject SU using the magnetic resonance imaging apparatus 1 of the aforementioned embodiment in accordance with the present invention will be described hereinbelow.

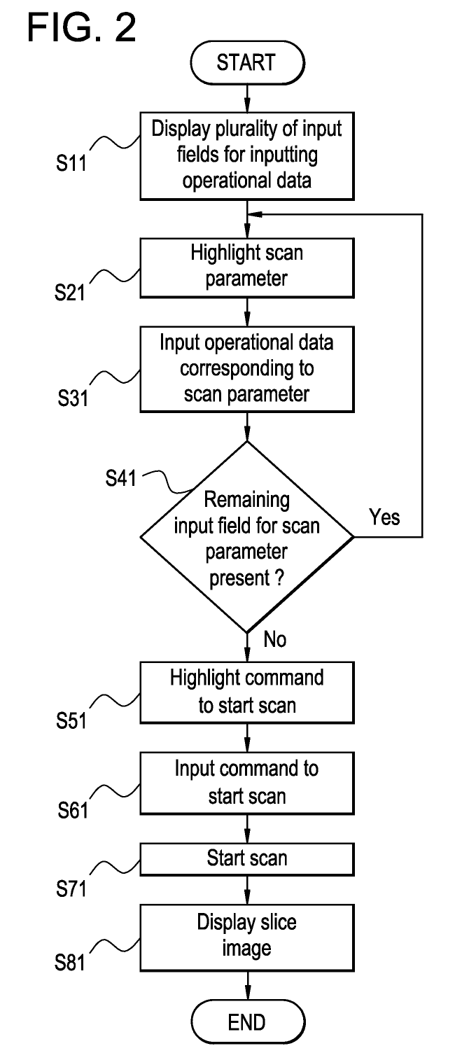

FIG. 2 is a flow chart showing an operation in imaging a subject in the present embodiment.

First, as shown in FIG. 2, a plurality of input fields for inputting operational data are displayed (S11).

Specifically, a plurality of images representing input fields for the operator to input operational data via the operating section 32 are displayed by the display section 33 on its display screen.

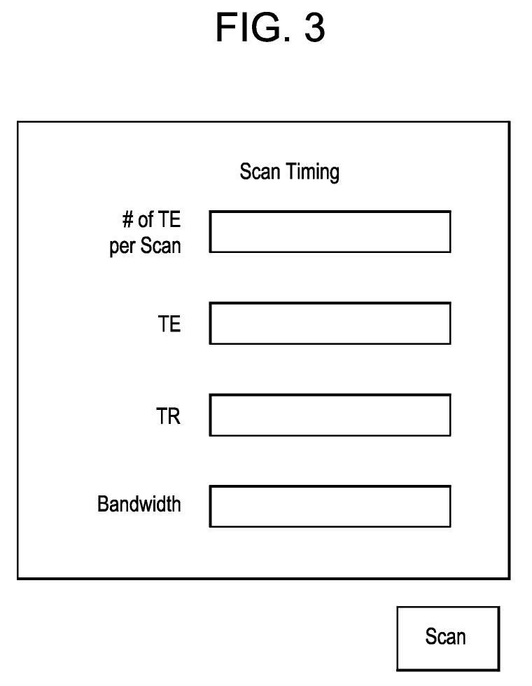

FIG. 3 shows images representing the input fields displayed by the display section 33 on its display screen in the present embodiment.

As shown in FIG. 3, for example, text information representing scan parameters including the number of echoes (# of TE per scan), echo time (TE), repetition time (TR), and band width (BW) are displayed by the display section 33 on its display screen, along with dialog boxes for inputting these parameters corresponding to the text information representing the parameters. Moreover, text information representing a command to start a scan (Scan) is displayed by the display section 33 on its display screen, along with a button for inputting the command.

Next, a scan parameter is highlighted, as shown in FIG. 2 (S21).

Specifically, the display section 33 sequentially highlights the plurality of scan parameters corresponding to the sequence of inputting stored by the storage section 34 in the plurality of input fields displayed by the display section 33 on its display screen.

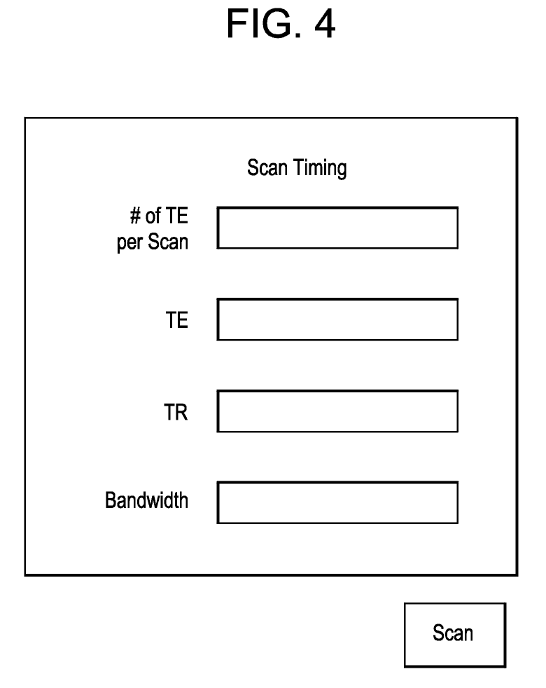

FIG. 4 shows images in which a scan parameter is highlighted by the display section 33 in the present embodiment.

For example, if the storage section 34 stores the sequence of inputting scan parameters including the number of echoes (# of TE per scan), echo time (TE), repetition time (TR), and band width (BW), an image of text information representing the number of echoes (# of TE per scan) among the plurality of scan parameters is first highlighted by the display section 33, as shown in FIG. 4. In particular, the image of text information representing the number of echoes (# of TE per scan) is highlighted by alternately displaying the image in two different colors such that only the image of text information blinks. The display section 33 thus displays the image of a scan parameter to be highlighted differently from images of the other scan parameters. Note that FIG. 4 shows the blinking of the image as a different font.

Next, as shown in FIG. 2, operational data corresponding to the scan parameter is input (S31).

Specifically, the operator inputs operational data for the scan parameter highlighted by the display section 33 using the keyboard in the operating section 32. The operational data input by the operator is output to the control section 30 by the operating section 32. Thereafter, the control section 30 outputs text information corresponding to the input operational data to the display section 33, which displays the text information corresponding to the operational data in a corresponding dialog box for the scan parameter.

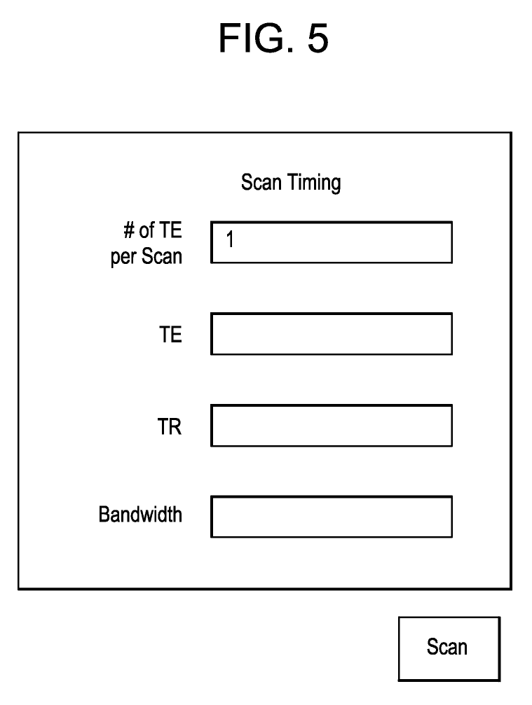

FIG. 5 shows images in which text information corresponding to the input operational data is displayed by the display section 33 in the present embodiment.

As shown in FIG. 5, operational data defining the number of echoes (# of TE per scan) as “1” is input by the operator using the keyboard in the operating section 32, and text information corresponding to the input operational data is displayed as text information in a corresponding dialog box for the scan parameter by the display section 33.

Next, presence of a remaining input field for a scan parameter is checked, as shown in FIG. 2 (S41).

Specifically, the control section 30 checks whether there is any remaining scan parameter present into which operational data is not input yet among the scan parameters corresponding to the sequence of inputting stored in the storage section 34. If there is a scan parameter present into which operational data is not input yet, the control section 30 causes the display section 33 to highlight the scan parameter corresponding to the sequence of inputting stored by the storage section 34, as shown in FIG. 2 (S21). Thereafter, similarly to the aforementioned process, operational data for the scan parameter is input (S31).

In particular, as shown in FIG. 5, after operational data for the number of echoes (# of TE per scan) has been input, the display section 33 highlights an image of text information representing the echo time (TE) according to the procedure of inputting stored in the storage section 34 as described above. Then, after operational data corresponding to the echo time (TE) has been input, the display section 33 highlights an image of text information representing the repetition time (TR). After operational data corresponding to the repetition time (TR) has been input, the display section 33 highlights an image of text information representing the band width (BW). Thus, in the present embodiment, after operational data corresponding to a first one of the plurality of input fields that is highlighted has been input by the operator via the operating section 32, the display section 33 highlights a second input field into which operational data is to be input next to the first input field according to the sequence of inputting stored by the storage section 34.

If there is no scan parameter remaining corresponding to the sequence of inputting stored in the storage section 34 into which operational data is not input yet, a command to start a scan is highlighted, as shown in FIG. 2 (S51).

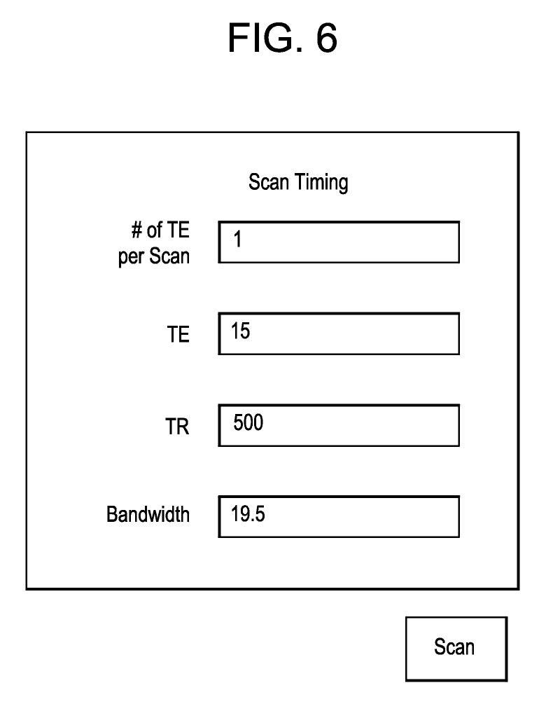

FIG. 6 shows images in which a command to start a scan is highlighted by the display section 33 in the present embodiment.

At this step, the display section 33 highlights only an image of text information representing a command to start a scan (Scan), as shown in FIG. 6. In particular, the image of text information representing the command to start a scan (Scan) is highlighted by alternately displaying the image in two different colors such that only the image of text information blinks.

Next, the command to start a scan is input, as shown in FIG. 2 (S61).

Specifically, operational data for starting a scan is input by the operator clicking on the button for starting a scan highlighted by the display section 33 using the pointing device in the operating section 32.

Next, a scan is started, as shown in FIG. 2 (S71).

Specifically, a scan corresponding to the input scan parameters is conducted by the scanning section 2 to acquire magnetic resonance signals as raw data from the subject SU laid in the imaging space B in which a static magnetic field is generated.

Next, a slice image is displayed, as shown in FIG. 2 (S81).

Specifically, a slice image of the subject SU is produced by the image producing section 31 based on the magnetic resonance signals acquired in the scan. The produced slice image is then output to the display section 33 by the image producing section 31, and is displayed by the display section 33 on its display screen.

As described above, in the magnetic resonance imaging apparatus 1 of the present embodiment, the storage section 34 stores a sequence of inputting operational data into a plurality of input fields displayed by the display section 33, and the display section 33 sequentially highlights the input fields corresponding to the sequence of inputting stored by the storage section 34. In particular, after operational data corresponding to a first one of the plurality of input fields that is highlighted has been input by the operator via the operating section 32, the display section 33 highlights a second input field into which operational data is to be input next to the first input field according to the sequence of inputting stored by the storage section 34. The present embodiment thus improves operability, and hence, imaging efficiency, since when the display section 33 displays on its display screen a plurality of input fields for the operator to input operational data, an input field to be input is easily recognizable by the operator.

It should be noted that the magnetic resonance imaging apparatus 1 in the embodiment above corresponds to the image diagnostic apparatus of the present invention. The scanning section 2 in the embodiment above corresponds to the scanning section of the present invention. The image producing section 31 in the embodiment above corresponds to the image producing section of the present invention. The operating section 32 in the embodiment above corresponds to the operating section of the present invention. The display section 33 in the embodiment above corresponds to the display section of the present invention. Finally, the storage section 34 in the embodiment above corresponds to the storage section of the present invention.

The present invention is not limited to being practiced in the aforementioned embodiment, and several variations may be employed.

For example, while description has been made on a case in which input fields including the number of echoes, echo time, repetition time, band width, and a command to start a scan are sequentially highlighted in the embodiment above, the present invention is not limited thereto. For example, the present invention is applicable to a case in which input fields including subject information such as the name and index number of the subject, imaging parameters such as the imaging plane, imaging mode, and type of a pulse sequence, a scan range such as the FOV, and slice thickness, and additional parameters such as multiple planar display are highlighted. Especially, the present invention is useful in a case requiring a complicated procedure such as when guiding a scan procedure in multiple stations.

Moreover, for example, while description has been made on a case in which highlight display is achieved by blinking an input field on the display screen in the embodiment above, the present invention is not limited thereto. For example, the highlight display may be achieved by modification of color or font, or addition of ornamented characters.

Furthermore, for example, while description has been made on a case in which a magnetic resonance imaging apparatus is employed as the image diagnostic apparatus in the embodiment above, the present invention is not limited thereto. The present invention is applicable to an X-ray CT apparatus and an ultrasonic diagnostic apparatus, for example.

Many widely different embodiments of the invention may be configured without departing from the spirit and the scope of the present invention. It should be understood that the present invention is not limited to the specification, except as defined in the appended claims.

1. An image diagnostic apparatus comprising an imaging apparatus for imaging a subject and an operating apparatus for operating said imaging apparatus, wherein said operating apparatus comprises:
a display device for displaying a plurality of input fields for an operator to input operational data; and
a storage device for storing a sequence of inputting said operational data into said plurality of input fields displayed by said display device,
said display device sequentially highlighting said input fields corresponding to said sequence of inputting stored by said storage device.

2. The image diagnostic apparatus of claim 1, further comprising:
an operating device via which said operational data is input by the operator, wherein
after said operational data corresponding to a first one of said plurality of input fields that is highlighted has been input by the operator via said operating device, said display device highlights a second input field into which said operational data is to be input next to said first input field according to said sequence of inputting stored by said storage device.

3. The image diagnostic apparatus of claim 1, wherein:
said display device blinks said input fields.

4. The image diagnostic apparatus of claim 1, wherein said imaging apparatus comprises:
a scanning device for scanning the subject to acquire raw data; and
an image producing device for producing an image of said subject based on the raw data acquired by said scanning device.

5. The image diagnostic apparatus of claim 4, wherein:
said scanning device conducts a scan for acquiring magnetic resonance signals from the subject laid in a static magnetic field space as said raw data; and
said image producing device produces an image of said subject based on said magnetic resonance signals acquired by said scan conducted by said scanning device.

6. The image diagnostic apparatus of claim 5, wherein:
said display device displays scan parameters for said scan conducted by said scanning device as said input fields.

7. The image diagnostic apparatus of claim 5, wherein:
said display device displays subject information on said subject on which said scan is conducted by said scanning device as said input fields.

8. The image diagnostic apparatus of claim 5, wherein:
said display device displays a command for said scanning device to start said scan as one of said input fields.

9. The image diagnostic apparatus of claim 6, wherein
said display device displays an echo time as one of said scan parameters.

10. The image diagnostic apparatus of claim 6, wherein
said display device displays a repetition time as one of said scan parameters.

11. The image diagnostic apparatus of claim 6, wherein
said display device displays a band width as one of said scan parameters.

12. The image diagnostic apparatus of claim 7, wherein
said display device displays a name of said subject as said subject information.
